(19) United States
(12) Patent Application Publication
(10) Pub. No.: US 2014/0098391 A1
(43) Pub. Date: Apr. 10, 2014

(54) GAME SERVER IN A MULTIFUNCTION PRINTER

(71) Applicant: Siow Kiat Tan, Singapore (SG)

(72) Inventor: Siow Kiat Tan, Singapore (SG)

(21) Appl. No.: 13/646,761

(22) Filed: Oct. 8, 2012

(51) Int. Cl. G06K 15/02

(52) U.S. Cl. 358/1.13

(57) ABSTRACT

A multifunction printer includes: a printing apparatus; a scanning apparatus; a network connection; an embedded web server for monitoring or administering the multifunction printer through web pages that are accessible to a web browser on a client station through the network connection; and a read only memory that is configured to store computer game or educational software, wherein the embedded web server is configured to provide one or more computer games or learning activities to one or more client stations over the network

### CROSS REFERENCE TO RELATED APPLICATION

Reference is made to commonly assigned, co-pending U.S. patent application Ser. No. ______ by Siow Kiat Tan, filed concurrently herewith, entitled: “Photo Editor in a Multifunction Printer”, the disclosure of which is incorporated herein.

### FIELD OF THE INVENTION

The present invention relates to a multifunction printer having an embedded web server, and more particularly to providing a game server in such a multifunction printer.

### BACKGROUND OF THE INVENTION

In the past, printers were typically connected directly to a host computer or to a local network. With the proliferation of smart mobile devices such as smart phones and tablets, it has become advantageous to facilitate easy wireless connection between such smart mobile devices and multifunction printers for printing documents, monitoring printer status and other printing or scanning related tasks. To accomplish this, some multifunction printers now include embedded web servers. The primary function of a web server is to provide web pages to deliver user content on request to clients using the Hypertext Transfer Protocol (HTTP). The user runs a web browser to interact with web servers. Embedding a web server in a printer provides a rich user interface to configure and control the multifunction printer and view the printer status using the comparatively large screen on the smart mobile device. The user connects to the printer through the IP address of the printer by browsing to the URL of the printer.

Popular features on smart mobile devices and networked computers include games and learning activities. Such games and learning activities can be for one person or for multiple people. Some types of games and learning activities are interactive between the person and the computer program. Types of interaction can include a) the game or learning activity program presenting a situation or question, b) the person entering a response, and c) the game or learning activity or another person providing feedback or a response to the first person's response. Although participation in many types of games and learning activities is best done using the smart mobile device's or networked computer's input/output capabilities (including a keyboard, a mouse, a display, a touch screen, a microphone, a speaker and similar devices), for other types of games and learning activities it is found that people prefer to interact using hard copy.

Furthermore for distributing computer games and learning activities it can be useful to have a web server. Web servers for interactive games on the network (called game servers) function as the authoritative source of events in a multiplayer video game. The server transmits enough data about its internal state to allow its connected clients to maintain their own accurate version of the game world for display to players. They also receive and process each player's input. Game servers are oriented toward computer input/output interaction as described above, and not toward hard copy interaction.

What is needed is a way to provide networking of games and learning activities and also facilitate easy interaction via hard copy.

### SUMMARY OF THE INVENTION

The present invention is directed to overcoming one or more of the problems set forth above. Briefly summarized, according to one aspect of the invention, the invention resides in a multifunction printer includes comprises: a printing apparatus; a scanning apparatus; a network connection; an embedded web server for monitoring or administering the multifunction printer through web pages that are accessible to a web browser on a client station through the network connection; and a read only memory that is configured to store computer game or educational software, wherein the embedded web server is configured to provide one or more computer games or learning activities to one or more client stations over the network.

### BRIEF DESCRIPTION OF THE DRAWINGS

FIG. 1 is a perspective view of a multifunction printer;

FIG. 2 is a schematic diagram showing how the different parts of the multifunction printer are related to one another and to external computers according to an embodiment of the present invention; and

FIG. 3 is a block diagram showing how an example of a web page related to a game application or learning activity application in the multifunction printer can be displayed on a smart mobile device or network computer according to an embodiment of the present invention.

### DETAILED DESCRIPTION OF THE INVENTION

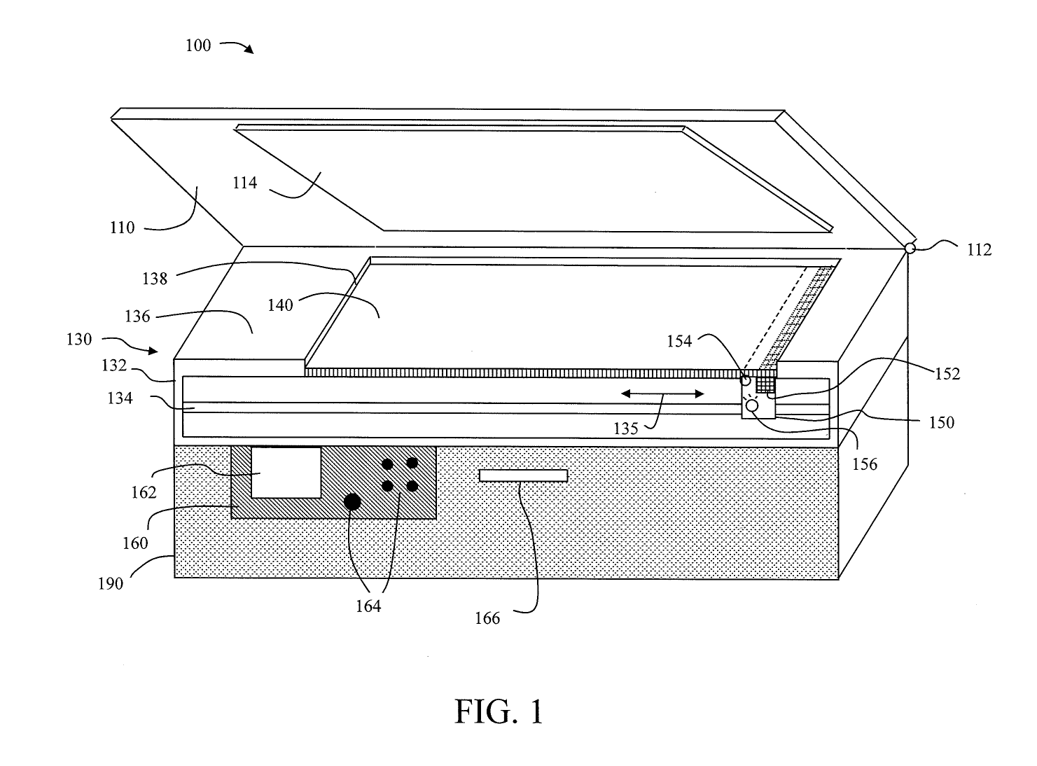

FIG. 1 shows a perspective of a multifunction printer 100 that can be used in embodiments of the invention. The multifunction printer 100 includes a scanning apparatus 130 for acquiring digitized images of documents or other objects, and a printing apparatus 190, which can be an inkjet printer for example. In this view, the front portion of the scanning apparatus 130 is cut away in order to show internal features of the scanning apparatus 130 more clearly. The multifunction printer 100 can do printing, scanning of documents, or copying of documents (i.e. printing plus scanning).

A control panel 160 for the apparatus is shown in FIG. 1 as being located on the front of the printing apparatus 190, but this was done partly for illustrative purposes so as not to obscure features of the scanning apparatus 130. The control panel 160 could alternatively be located on the top or the front of the scanning apparatus 130 for example. The control panel 160 can include a display 162 and a variety of control buttons 164. For cases where the display 162 is a touch screen, the control buttons 164 can be integrated into the touch screen rather than being separate from it. Also shown is a memory reader 166 for reading memory devices such as memory cards or flash drives when they are inserted. Photos or other electronic images can be directly provided to the multifunction printer 100 through the memory reader 166.

The scanning apparatus 130 includes a scanning apparatus body 132 and a scanner lid 110, which is joined to the scanning apparatus body 132 by a hinge 112. The surface of the scanning apparatus body 132 that is covered by the scanner lid 110 when the scanner lid 110 is closed includes a frame 136. A transparent platen 140 (typically a flat piece of glass) is inset within the frame 136. In the example shown in FIG. 1, the surface of the transparent platen 140 is lower than the surface of the frame 136 so that there is an offset 138. The transparent platen 140 is not covered by the scanner lid 110 when the scanner lid 140 is open as it is in FIG. 1.

Below the transparent platen 140 is a movable sensor array module 150. In the example shown in FIG. 1, the sensor array module 150 includes a photosensor array (such as a contact image sensor) 152 extending the width of the transparent platen 140, a roller 154 that is biased into contact with the underside of the transparent platen 140, and a light source 156 that illuminates a scan line of a document or other item (not shown) that is placed on top of the transparent platen 140. A light guide (not shown) and other optics (not shown) can also be included in the sensor array module 150. The sensor array module 150 is moved back and forth along a scanning guide 134 in a direction 135 across the length of the transparent platen 140 in order to scan the document or other item, receiving reflected light from the item through the transparent platen 140 scan line by scan line and converting the reflected light into electrical signals. A controller (not shown) converts the electrical signals into digitized data to form a digitized image of the item. The scanning guide 134 can be a round rail, a rack and pinion or other guiding member that can use the power of a motor (not shown) to provide a linear motion along the scanning direction 135. In FIG. 1, the sensor array module 150 is parked in its home position near one end of the transparent platen 140. The home position is where the sensor array module 150 returns between scanning operations.

The scanner lid 110 includes a reflective backing plate 114. The thickness of the reflective backing plate 114 is accommodated in the offset 138 between the frame 136 and the top surface of the transparent platen 140 when the scanner lid 110 is closed. The reflective backing plate 114 can be resiliently mounted on the scanner lid 110, so that the reflective backing plate 114 is effective in pressing documents of various thicknesses against the transparent platen 140. Typically the reflective backing plate 114 is white in the document scanning region. Since many documents are printed on white paper, a white reflective backing plate 114 results in an overall white background even for documents of sizes that are smaller than the scanning region. For other types of objects to be scanned, such as photos, the white reflective backing plate 114 produces a clean background that provides good contrast for the photos. In other scanning apparatus designs, the reflective backing function is integrated into the scanner lid 110.

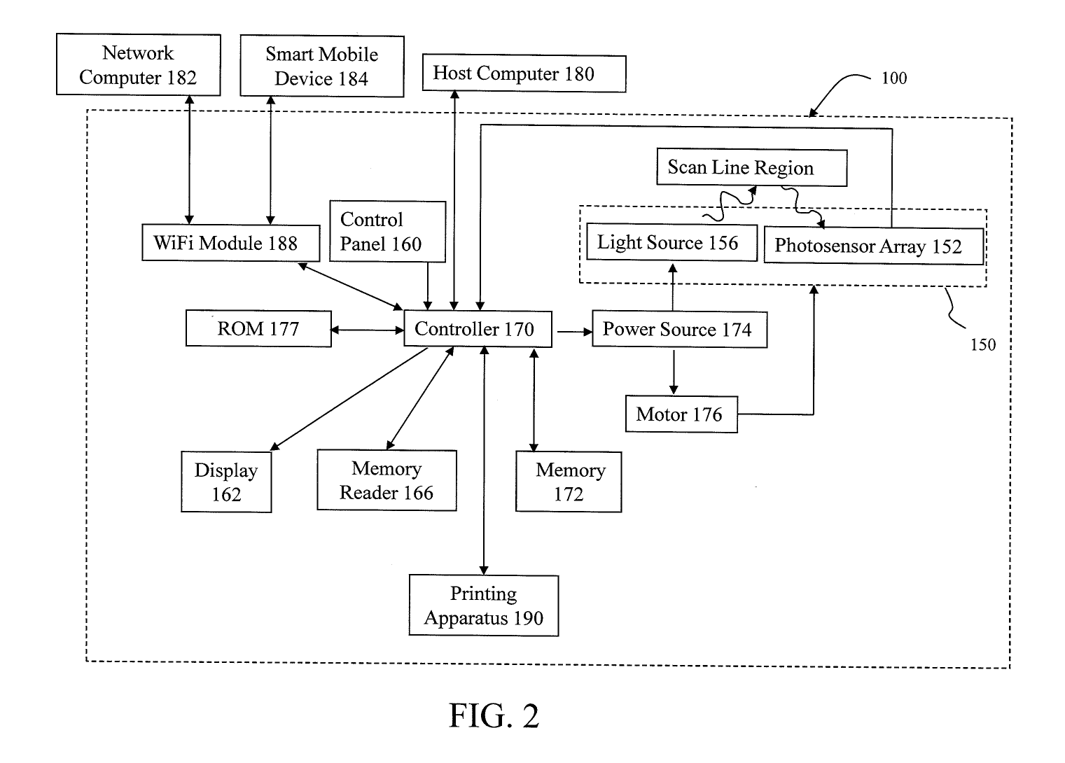

FIG. 2 schematically shows the relationship of components of the multifunction printer 100 and computers (such as a host computer 180 or a network computer 182) or a smart mobile device 184 that the multifunction printer 100 is connected. A user can initiate a printing or scanning operation from the control panel 160, or alternatively from the host computer 180 or the network computer 182 or the smart mobile device 184. For a scanning operation, for example, a signal is sent to a controller 170, which then sends a signal to a power source 174 to turn on the light source 156 and also to operate a motor 176 in order to move the sensor array module 150 along the scanning direction 135 (see FIG. 1). As the sensor array module 150 is moved, light from the light source 156 reflects off a document or other object that is placed on the transparent platen 140 and impinges on the photosensor array 152 one scan line at a time. A scan line signal is sent from the photosensor array 152 to the controller 170 where it can be further processed before sending it to a memory 172 (or to the host computer 180 for example) in order to compose an entire scanned image signal, scan line by scan line. When the scan is completed, the controller 170 sends a signal to the power source 174 to send power to the motor 176 in order to return the sensor array module 150 to its home position. For printing or scanning operations initiated by the network computer 182 or the smart mobile device 184, data transmission to or from the controller is done through a WiFi module 188.

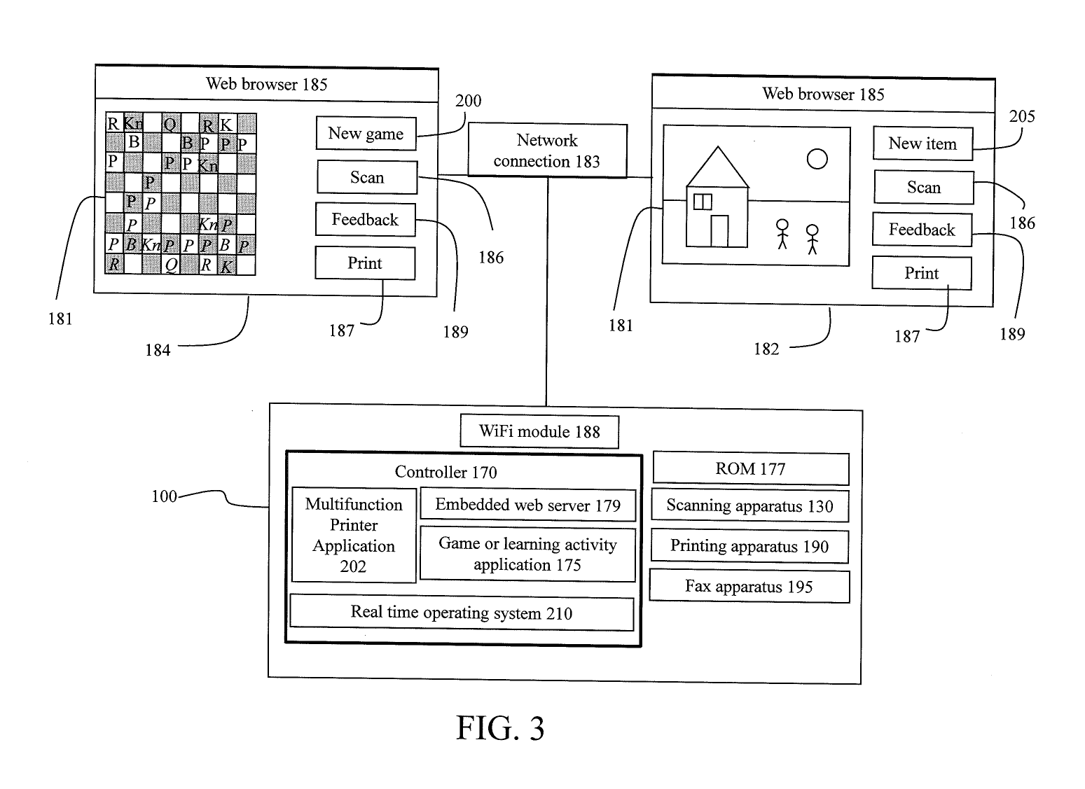

As shown in FIG. 3, embodiments of the present invention provide a game application or learning activity application 175 written in a device independent programming language, such as Javascript, and stored in a read only memory 177. Because a device independent programming language is used, the game application or learning activity application 175 is able to execute on a wide variety of computing platforms, as long as the computing platform has a modern web browser. An embedded web server 179 provides web pages to a client station through a network connection 183 for monitoring and administering the multifunction printer 100. A user operating a client computing device, such as the network computer 182 or the smart mobile device 184 runs a web browser 185 and browses to the URL of the multifunction printer 100. The game application or learning activity application 175 loads and runs on the web browser 185 without requiring additional software to be installed on the client computing device. In addition, since a Javascript program runs in the web browser 185, it does not use the controller 170 or other microprocessors in the multifunction printer 100, so that normal functions such as printing or scanning are not impacted.

In some embodiments the multifunction printer 100 includes a fax apparatus 195 in addition to a printing apparatus 190 and a scanning apparatus 130. The controller 170 functions as a system manager and operates the various multifunction printer applications 202 as well as the embedded web server 179 and the game or learning activity application 175 via a real time operating system 210.

The multifunction printer 100 is used as a repository for computer games or learning activities served over the network to client computing devices, using the embedded web server 179 to stream games or learning activities to web browsers on the client computing devices. Only one copy of the game or educational software needs to be stored on the multifunction printer 100 for multiple client stations to participate simultaneously or independently. The multifunction printer 100 provides several methods to install new games or learning activities including by a firmware upgrade, by a plug-in module from the Internet, by local storage (such as a USB thumb drive or and SD card) read by the memory reader 166 (see FIG. 1), or by networked storage (such as a networked storage drive or a shared folder on the network computer 182).

Although using the multifunction printer 100 as a repository for computer games or learning activities is a useful function in itself, the present invention is particularly advantageous for facilitating hard copy interaction with the game or learning activity. As shown in FIG. 3, the game or learning activity application 175 provides a browser-based user interface via the embedded web server 179 for the user to view a game or learning activity in a viewer window 181. Using various buttons provided by the web browser 185 for the particular game or learning activity, the user can interact with the game or learning activity, including through hard copy.

In the example shown in FIG. 3 of the viewer window 181 for the smart mobile device 184 a chess game is being viewed. This is an example of hard copy interaction where the user can scan in a game starting configuration that is different than the usual starting configuration. There is a rich database of chess games documented in books. The user can scan in a board configuration that the user wants to start with for either playing with another person, or playing against the computer. For example, the user can practice his strategy given a particular board configuration, or perhaps one player is more skillful than the other, and the more skillful player would be given the more difficult starting position. The player can touch soft control. A scan button 186 provided on the screen of their smart mobile device 184 or network computer 182 to initiate scanning the page in the chess book using the scanning apparatus 130 of the multifunction printer 100, thereby providing digitized data corresponding to the user's hard copy interaction. The game application 175 can recognize the chess board configuration by use of commonly used chess notation and can set up the game in the viewer window 181 of the smart mobile device 184 to start there.

Other types of games including crossword puzzles, sudoku, numerical puzzles, and jigsaw puzzles are typically done by one person. The game application 175 would provide a web page through the embedded web server 179 to the smart mobile device 184 or the network computer 182. The user would select a puzzle or game with a soft control New Game button 200. Then the user can print the puzzle or game on the printing apparatus 190 of multifunction printer 100 using a soft control Print button 187. The user can complete the game or puzzle on hard copy. If desired, particularly if the user gets stuck, the user can use a soft control Scan button 186 to initiate a scan of his partially completed game or puzzle. The user can then press a soft control Feedback button 189 and the web page can provide a hint.

In the example of the viewer window 181 for the network computer 182 a coloring page is being viewed. This is an example of a learning activity. A line drawing can be provided for a person (such as a child) to color by pressing a New Item button 205. Coloring pages can be generated from a stockpile of generic images, or line drawings can be generated from photographs entered into the multifunction printer 100 by use of the scanning apparatus 130 (see FIG. 1 also), or the memory reader 166 (see FIG. 1), or a folder on computer. The soft control Print button 187 can be used to print a hard copy of the coloring page line drawing on the printing apparatus 190. Then the person colors the hard copy line drawing. Optionally, the user can then initiate a scan of the colored hard copy line drawing by pressing the soft control Scan button 186. If desired the user can then press the soft control Feedback button 189 and the web page can facilitate feedback, either from an image analysis program or by initiating a feedback request by a person (such as a teacher or a parent).

Other types of games or learning activities include math puzzles, games involving maps, connect the dots drawings, and the like. Sometimes the difference between a game and a learning activity is not very distinct. For example, in the chess example described above, it can be a learning activity as well as a game. In some instances the activity is clearly a game that is played for amusement without significant learning. In other instances an activity can be strictly a learning activity. For example, in an classroom setting, a teacher can use the learning activity application 175 to scan student answer sheets and have the correct answers or corrections printed out.

Providing the game application or learning activity application 175 in the multifunction printer 100 having the embedded web server 179 has several advantages relative to installing a game application or learning activity application on the smart mobile device 184 or on the network computer 182, as well as relative to using an Internet web site implementation:

1. The game application or learning activity application 175 in the multifunction printer 100 is accessible to client stations within the local network without having to access the Internet. This removes concern on data privacy and data usage costs.

2. The game application or learning activity application 175 in the multifunction printer 100 is able to print images, such as scenes from the game, even if the client station does not have a suitable printer driver for the multifunction printer 100. It achieves this by directly uploading print content of the client station from the web browser 185 through the embedded web server 179.

3. The game application or learning activity application 175 in the multifunction printer 100 is able to optimize its print output for the destination recording media in terms of printable area and media type, for example, without user intervention. This is made possible because the web browser 185 has a bidirectional link with the embedded web server 179 and the printing subsystem 190, typically through the controller 170.

4. The scanning apparatus 130 in the multifunction printer 100 can provide its scan capability as an easy way to customize and interact with the game or learning activity via hard copy.

5. The game application or learning activity application 175 is personal. The user controls what games or learning activities to install and run.

The present invention has been described in detail with particular reference to certain preferred embodiments thereof, but it will be understood that variations and modifications can be effected within the spirit and scope of the invention.

### PARTS LIST

100 Multifunction printer
110 Scanner lid
112 Hinge
114 Reflective backing plate
130 Scanning apparatus
132 Scanning apparatus body
134 Scanning guide
135 Scanning direction
136 Frame
138 Offset (for reflective backing plate)
140 Transparent platen
150 Sensor array module
152 Photosensor array
154 Roller of sensor array module
156 Light source
160 Control panel
162 Display
164 Control buttons
166 Memory reader
170 Controller (system manager)
172 Memory
174 Power source
175 Game application or learning activity application
176 Motor
177 Read Only Memory (ROM)
179 Embedded web server
180 Host computer
181 Viewer window
182 Network computer
183 Network connection
184 Smart mobile device
185 Web browser
186 Scan button
187 Print button
188 WiFi module
189 Feedback button
190 Printing apparatus
195 Fax apparatus
200 New game
202 Multifunction printer applications
205 New item
210 Real time operating system

1. A multifunction printer comprising:
a printing apparatus;
a scanning apparatus;
a network connection;
an embedded web server for monitoring or administering the multifunction printer through web pages that are accessible to a web browser on a client station through the network connection; and
a read only memory that is configured to store computer game or educational software, wherein the embedded web server is configured to provide one or more computer games or learning activities to one or more client stations over the network.

2. The multifunction printer of claim 1, where the computer game or educational software is written in a device independent programming language.

3. The multifunction printer of claim 1, wherein the one or more computer games or learning activities are configured to be accessible to client stations within a local network without requiring the client stations to access the Internet.

4. The multifunction printer of claim 1, wherein the multifunction printer is configured to accept computer-game-related or learning-activity-related print content uploaded from the web browser of the client station through the embedded web server.

5. The multifunction printer of claim 4, wherein print output of the printing apparatus corresponding to the print content from the web browser is configured to be optimized according to size or type of recording medium in the printing apparatus without user intervention.

6. The multifunction printer of claim 1, wherein the scanning apparatus is configured to acquire digitized data corresponding to user hardcopy interaction with the one or more computer games or learning activities.

7. The multifunction printer of claim 1 further comprising a reader for a memory storage device.

8. The multifunction printer of claim 7, wherein the read only memory is configured to receive computer game or educational software uploaded by the memory storage device reader.

9. The multifunction printer of claim 1, wherein the read only memory is configured to receive computer game or educational software through a firmware update of the multifunction printer.

10. The multifunction printer of claim 1, wherein the read only memory is configured to receive computer game or educational software through networked storage.
